(19) United States
(12) Patent Application Publication
(10) Pub. No.: US 2026/0189399 A1
(43) Pub. Date: Jul. 2, 2026

(54) RESILIENT DETERMINISTIC ENCRYPTION EXTENSION USING ASSOCIATED METADATA STRUCTURES

(71) Applicant: INTERNATIONAL BUSINESS MACHINES CORPORATION, Armonk, NY (US)

(72) Inventor: Glen Alan Jaquette, Tucson, AZ (US)

(21) Appl. No.: 19/003,724

(22) Filed: Dec. 27, 2024

(51) Int. Cl. H04L 9/32

(52) U.S. Cl. CPC H04L 9/3242

(57) ABSTRACT

Deterministic encryption of data is provided that facilitates subsequent data deduplication. An input data block is read. A compressibility of the input data block is determined. The data block is compressed when the compressibility exceeds a predetermined threshold. The data block is encrypted based on a keyed hash. The encrypted data block is provided with associated metadata, the associated metadata comprising an indication of the compressibility and the keyed hash.

### BACKGROUND

Embodiments of the present disclosure relate to data encryption, and more specifically, to implementing deterministic encryption of data that facilitates subsequent data deduplication.

### BRIEF SUMMARY

According to embodiments of the present disclosure, methods of and computer program products for data encryption are provided. An input data block is read. A compressibility of the input data block is determined. The data block is compressed when the compressibility exceeds a predetermined threshold. The data block is encrypted based on a keyed hash. The encrypted data block is provided with associated metadata, the associated metadata comprising an indication of the compressibility and the keyed hash.

### BRIEF DESCRIPTION OF THE SEVERAL VIEWS OF THE DRAWINGS

FIG. 1 depicts a cloud computing environment according to embodiments of the present disclosure.

FIG. 2 depicts abstraction model layers according to embodiments of the present disclosure.

FIG. 3 is a flowchart illustrating a method of data encryption according to embodiments of the present disclosure.

FIG. 4 illustrates a tiered data storage system according to embodiments of the present disclosure.

FIGS. 5A-B provide a table illustrating various attributes of the present disclosure relative to DRAPE.

FIG. 6 depicts a computing node according to an embodiment of the present disclosure.

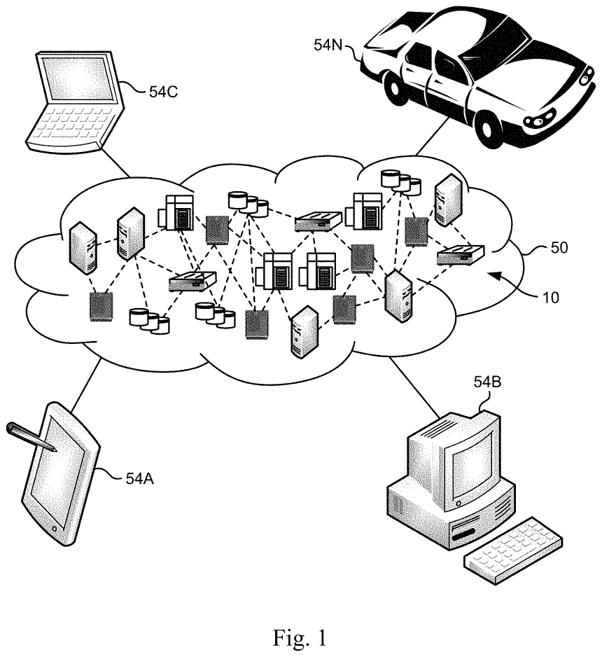

### DETAILED DESCRIPTION

Deterministic encryption of data before it is written to data storage is useful in that it allows duplicates of encrypted data to be identified and removed within such data storage. Length Preserving Compression (LPC) is a concept that enables a storage system to perform data compression of data that was already persistently encrypted at the host.

Resilient Deterministic Encryption (sometimes referred to herein as DRAPE) extends the LPC concepts to enable server-side encoding, including both compression and encryption, which also enables subsequent data deduplication. This allows a data reduction capable storage solution to achieve full data reduction on data which was previously DRAPE-encoded. In this context, full data reduction refers to enabling both compression and data deduplication. This form of DRAPE enables DRAPE-encoded data to be passed across a storage-fabric into a storage controller without any associated metadata.

In exemplary DRAPE systems, encoding involves two different encoding schemes—Scheme 1 for sufficiently compressible data, and Scheme 2 for incompressible data. Scheme 2,which applies to incompressible data, calls for XTS encryption of the uncompressed data. In some embodiments, the Logical Block Address number (LBA#) is used as the tweak value when XTS encryption is performed. In comparison, Scheme 1 uses convergent encryption, which employs a keyed hash as the tweak value when XTS encryption is performed. This in turn enables data deduplication of that Scheme 1 encoded data. Thus, Scheme 2 encoded data cannot be deduplicated (having been encoded according to Scheme 2 due to its incompressible nature).

For storage solutions such as Ceph (and other similar Software Defined Storage (SDS) solutions), the constraints that force DRAPE's Scheme 2 to be non-expanding can be relaxed. Specifically, when solutions such as Object Store are implemented in SDS solutions, there can be associated metadata structures that allow associated data to be recorded in parallel with the recording of the block storage.

The present disclosure uses associated metadata that can be passed in parallel with each fixed block of data to be encoded (which is referred to herein as DRAPE′). Specifically, DRAPE's Scheme 2, for incompressible data, is improved through the inclusion of an additional scheme referred to as Scheme 2″ herein. In the case of DRAPE's Scheme 2, there is no room to store a 2-byte As_Encoded fields or a 16-byte Keyed Hash field, which Scheme 1 uses to enable convergent encryption. Embodiments of the present disclosure leverage associated metadata structures to allow for those 18 bytes to be recorded elsewhere (e.g., as associated metadata). This enables convergent encryption to be used to encrypt incompressible data (using Scheme 2″).

The minimum overhead of DRAPE encoding depends on which Scheme is used. This in turn depends on the compressibility of the data pre-encoding. For Scheme 1, it is approximately (depending on allocation) 34 bytes, including 2 bytes for the header (the As_Encoded bytes), 16 bytes for the keyed hash (for convergent encryption), and 16 bytes for the minimum Zero Pad. For Scheme 2, 0 bytes. This means that under unmodified Scheme 2, the encoded data cannot be subsequently deduplicated (since standard XTS encryption, which uses the LBA#as the tweak, has to be used), compression is not available (even if minimal), and there is no room for information to say whether the fixed block data was compressed before encryption or not.

By making used of metadata fields, increased functionality is provided for both Scheme 1 and Scheme 2 encoding.

The metadata overhead for Scheme 1′ is approximately (depending on allocation) 18 bytes, including 2 bytes for the header (the As_Encoded bytes), which may be stored as associated metadata, 16 bytes for the keyed hash (for convergent encryption), which may also be stored as associated metadata, and 0 bytes (minimum Zero Pad). There is no required minimum zero pad because there is only one bit of information to communicated, which is whether Scheme 1′ or Scheme 2″ encoding was used. That bit of information can be stored instead as one of the bits in the As_Encoded field.

The metadata overhead for Scheme 2″ is also 18 bytes, including 2 bytes for the header (the As_Encoded bytes), which may be stored as associated metadata, 16 bytes for the keyed hash (to enable convergent encryption), which may also be stored as associated metadata, and 0 bytes (minimum Zero Pad). There is no required minimum zero pad because there is only one

bit of information to communicated, which is whether Scheme 1′ or Scheme 2″ encoding was used. That can be stored instead as one of the bits in the As_Encoded field.

The Scheme 2″ encoded data can be deduped (since the keyed hash was used as the XTS tweak value, which results in convergent encryption). No compression is required when outputting in Scheme 2″. There is room for one bit of information in the As_Encoded field to say whether the fixed block data was compressed before encryption. This requires 18 bytes of overhead (all stored as associated metadata), but the resultant cipher text can be deduplicated.

As set forth above, the two format fields provided in exemplary Scheme 2″ encoding of insufficiently compressible data enable deduplication without having to resort to use of more computationally-intensive wide-block encryption modes (such as EME2). In various embodiments, those two additional format fields associated with Scheme 2″ encoding in associated metadata are passed in parallel with the encoded (compressed and encrypted) user data. In various embodiments, data deduplication of Scheme 2″ encoded data is possible without having to recalculate a hash (e.g., by using the keyed hash in the associated metadata as the hash used by the deduplication algorithm).

### Exemplary Resilient Deterministic Encryption

An exemplary convergent encryption system uses a keyed hash as XTS's tweak value. This keyed hash could be a hash calculated across the data and a hashing key, an HMAC calculated based on the data and hashing key, or an encryption (e.g., using electronic codebook (ECB) encryption, etc.) of a simple cryptographic hash of the plaintext data. The hashing key might have a key derivation relationship with the key used to encrypt host data, or may be generated independently of it. The keyed hash, or a subset of it, is then used, during XTS encryption, as the tweak value. This tweak value will typically be sent along with the resultant ciphertext so that it is available for decryption.

By inclusion of a hashing key, which has high entropy independent of the host data, in the calculation of the keyed hash (which is used as XTS's tweak value), this implementation reduces potential vulnerabilities since both the tweak value and the resultant ciphertext are cryptographically created with secret keys an attacker does not have. This feature may be referred to as resilient deterministic encryption (RDE).

For encryption of plaintext P with RDE using a secret key K, one exemplary aspect would include creating a keyed hash (e.g., based on K) and then using that keyed hash as the tweak value which is used in conjunction with the secret key K when performing XTS. In the case of XTS, there are actually two equal-length keys: the encryption key K1 and the tweak key K2. The XTS secret key K is considered to be the concatenation of those K1 and K2, and is thus twice as long as either. For example, when used with AES-256, both K1 and K2 are 256-bits long and the XTS secret key K is thus 512 bits long.

In one aspect, K may be associated with a specific tenant as part of a secure multi-tenant solution. In another aspect, K may be associated with a subset of users and/or applications (e.g., human resources, finance, etc.) within a given tenant's operations.

The generation of one type of keyed hash Hk is described below:

$$Hk = hash ( Kh ‖ P )$$

In an exemplary implementation using XTS, the key Kh used to calculate the keyed hash could be equal to its K1 or its K2. Alternatively, Kh could be some other subset of K, or be derived from K or some subset of K.

Examples of suitable cryptographic hash functions would be SHA2-256, SHA3-256, or another standardized cryptographic hash. The generation of the encrypted result CX is described below:

$$CX = encrypt\_data ( K , Hk , P )$$

While the encrypt_data function described above corresponds to AES encryption in XTS mode, other encryption modes (e.g., CBC, CTR, or GCM) may also be used. Encryption modes that require the generation, use, and communication of an initialization vector (IV), nonce, or initial count, such as such as CBC or CTR modes, come at the cost of additional overhead and reduced efficiency. Similarly, authenticated encryption modes such as CCM or GCM require communication of the associated MAC, which increases overhead. Thus, while encryption modes other than XTS can be used, they typically come at the cost of additional overhead. While the keyed hash described above can be used as XTS's tweak value, it could also be used as the IV of a mode such as CBC or as a starting count value of a mode such as CTR. While the term tweak value is used herein by way of example, the present disclosure is not limited to use of XTS.

If the hash function output is larger than the keyed hash required (e.g., than the XTS tweak value), or that the selected encryption mode will accept, then a subset of the hash may be used. For example, the IV may be set to the first twelve (or sixteen, depending on the need) bytes out of a thirty-two byte SHA-256 output. For use of most modes other than XTS, the CX result of the encrypt_data function is larger than the plaintext input P. The resultant CX of the CTR mode includes the IV concatenated with the ciphertext of P. If an authenticated encryption mode such as GCM is used, the CX includes the trailing MAC (e.g., the GCM-MAC) as well. In either case the CX is longer (e.g., by the IV at a minimum, and possibly by a MAC as well) than the P being encrypted.

After generating the encrypted result CX, CX is transmitted or stored. CX, as constructed, is fully deterministic for any given combination of secret key (K) and plaintext (P), which allows different ciphertext strings (CXs) created from different instances of identical plaintext to be deduplicated against one another.

The decryption of the encrypted result CX using the secret key K and the keyed hash Hk, which may have been communicated separately as associated metadata, to obtain the plaintext P is described below:

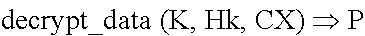

In the case of modes such as CBC or CTR, where the IV was concatenated with the encrypted plaintext to create CX, the decrypt data function would be

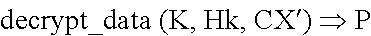

where the CX communicated was parsed into IV or initial count (shown here as Hk) and the remainder of CX is shown as CX′.

In one aspect, if an authenticated mode such as GCM was used for encryption, the values of Hk and P are only passed on or trusted as valid in response to determining that the integrated MAC has been confirmed as valid.

In another aspect, the Hk may be used to confirm that nothing in the encrypted result CX was modified. More specifically, given the secret key K and the plaintext P, the receiver/reader of the encrypted result CX is able to calculate the keyed hash of the secret key K and the plaintext P (e.g., hash (K∥P)) to see if it matches the IV that is received. If the calculated hash matches the IV, the integrity of the encrypted result CX may be confirmed.

In the case where the encryption mode used is not authenticated (e.g., standard CTR or CBC), this integrity check may act as a type of MAC calculated on the plaintext P before encryption, which can be used as a secure authentication tag if an appropriate encryption mode is used.

It is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

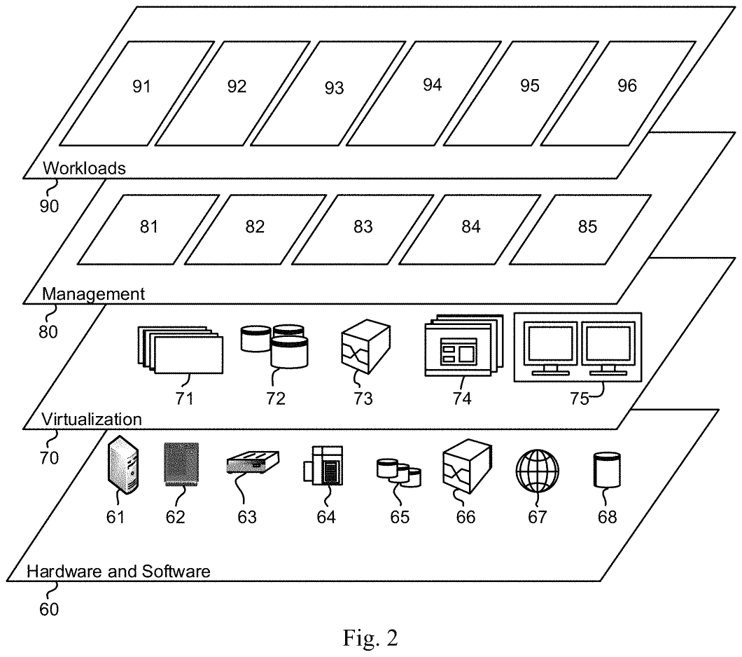

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

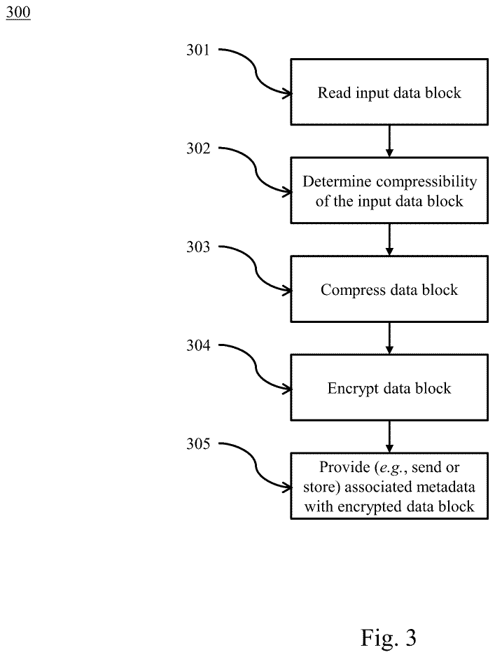

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the disclosure are not limited thereto. As depicted, the following layers and corresponding functions are provided:
Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and data encryption.

Referring to FIG. 3, an exemplary methods of data encryption according to embodiments of the present disclosure is illustrated. At 301, an input data block is read. At 302, a compressibility of the input data block is determined. At 303, the data block is compressed when the compressibility exceeds a predetermined threshold. At 304, the data block is encrypted based on a keyed hash. At 305, the encrypted data block is provided with associated metadata, the associated metadata comprising an indication of the compressibility and the keyed hash.

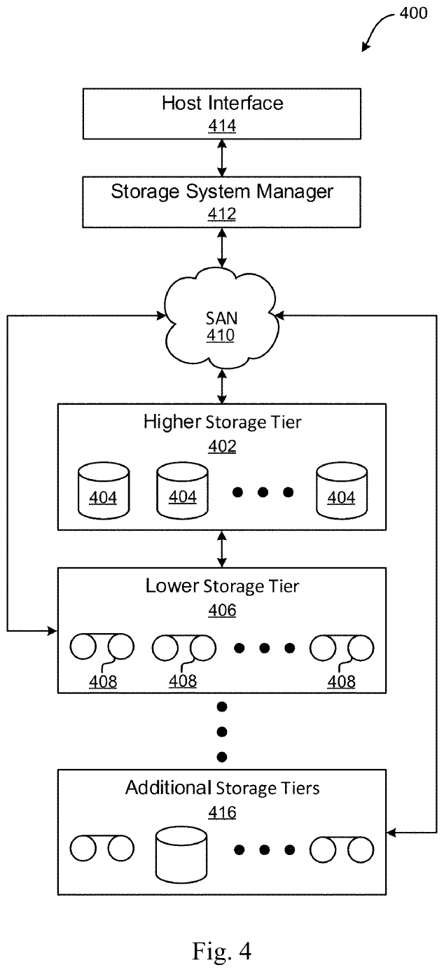

Now referring to FIG. 4, a storage system 400 is shown according to one aspect. Note that some of the elements shown in FIG. 4 may be implemented as hardware and/or software, according to various aspects. The storage system 400 may include a storage system manager 412 for communicating with a plurality of media on at least one higher storage tier 402 and at least one lower storage tier 406. The higher storage tier(s) 402 preferably may include one or more random access and/or direct access media 404, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 406 may preferably include one or more lower performing storage media 408, including sequential access media such as magnetic tape in tape drives and/or optical media, slower accessing HDDs, slower accessing SSDs, etc., and/or others noted herein or known in the art. One or more additional storage tiers 416 may include any combination of storage memory media as desired by a designer of the system 400. Also, any of the higher storage tiers 402 and/or the lower storage tiers 406 may include some combination of storage devices and/or storage media.

The storage system manager 412 may communicate with the storage media 404, 408 on the higher storage tier(s) 402 and lower storage tier(s) 406 through a network 410, such as a storage area network (SAN), as shown in FIG. 4, or some other suitable network type. The storage system manager 412 may also communicate with one or more host systems (not shown) through a host interface 414, which may or may not be a part of the storage system manager 412. The storage system manager 412 and/or any other component of the storage system 400 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more aspects, the storage system 400 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 402, may include a majority of SSD storage media for storing data in a higher performing storage environment, and remaining storage tiers, including lower storage tier 406 and additional storage tiers 416 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 402, while data not having one of these attributes may be stored to the additional storage tiers 416, including lower storage tier 406. Of course, one of skill in the art, upon reading the present descriptions, may devise many other combinations of storage media types to implement into different storage schemes, according to the aspects presented herein.

According to some aspects, the storage system (such as 400) may include logic configured to receive a request to open a data set, logic configured to determine if the requested data set is stored to a lower storage tier 406 of a tiered data storage system 400 in multiple associated portions, logic configured to move each associated portion of the requested data set to a higher storage tier 402 of the tiered data storage system 400, and logic configured to assemble the requested data set on the higher storage tier 402 of the tiered data storage system 400 from the associated portions.

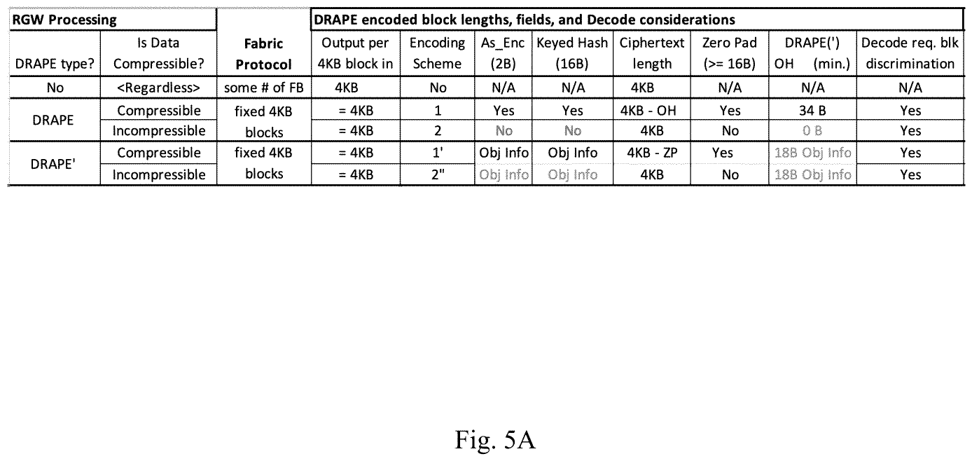

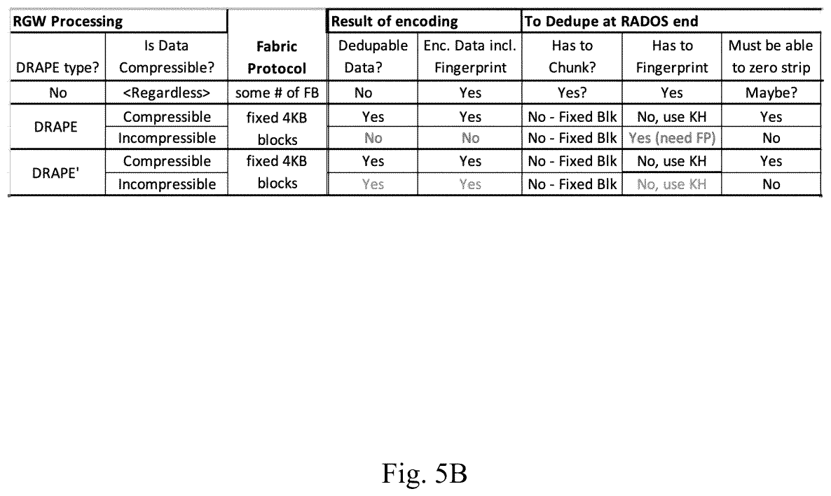

Referring to FIG. 5A-B, a table illustrating various attributes of the present disclosure relative to DRAPE is provided. In particular, DRAPE′, as set forth herein is a valid processing option for Ceph RGW. In this example, Scheme 1′ is similar to DRAPE Scheme 1 except the As_Enc and Keyed Hash fields are kept in Object Info metadata, and there is no need for ZP to be 16B minimum. For Scheme 2″, because As_Enc and Keyed Hash fields can be kept in Object Info metadata, Ceph can handle the incompressible data case without reverting to standard XTS and losing the ability to dedupe (as is the case with unmodified DRAPE Scheme 2).

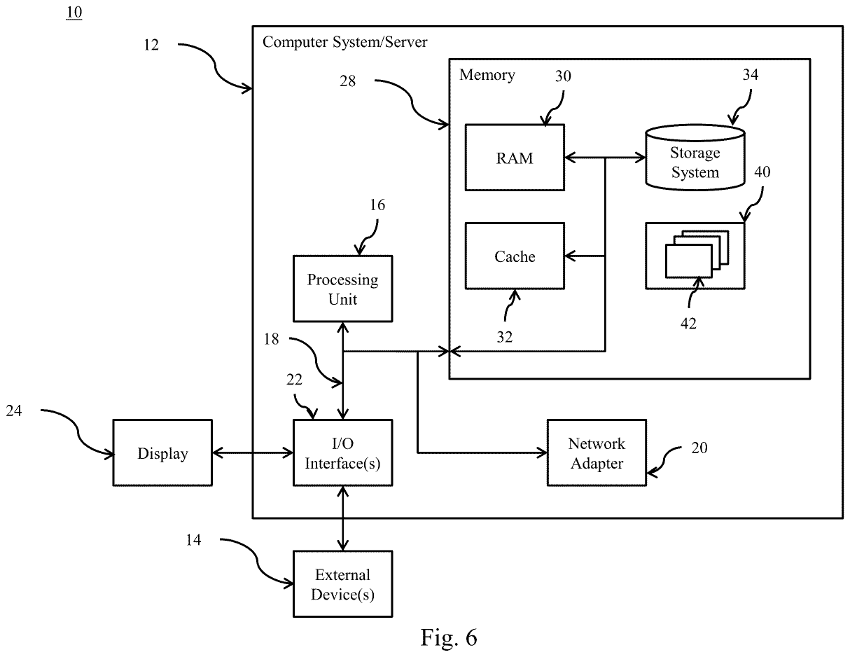

Referring now to FIG. 6, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of data encryption, comprising:
reading an input data block;
determining a compressibility of the input data block;
compressing the data block when the compressibility exceeds a predetermined threshold;
encrypting the data block based on a keyed hash; and
providing the encrypted data block with associated metadata, the associated metadata comprising an indication of the compressibility and the keyed hash.

2. The method of claim 1, wherein reading the input data block comprises reading a data stream and extracting the input data block therefrom.

3. The method of claim 1, wherein determining the compressibility of the input data block comprises compressing the input data and comparing a compressed length thereof to an uncompressed length thereof.

4. The method of claim 1, wherein said compressing comprises applying a convergent encryption scheme.

5. The method of claim 1, wherein the keyed hash is computed from the data block.

6. The method of claim 1, wherein the indication of the compressibility is a binary flag.

7. The method of claim 1, further comprising deduplicating the encrypted data block against a plurality of additional encrypted data blocks.

8. The method of claim 7, further comprising passing the encrypted data block and associated metadata in parallel to a storage controller, and wherein said deduplicating is performed by the storage controller.

9. A system comprising:
a computing node comprising a computer readable storage medium having program instructions embodied therewith, the program instructions executable by a processor of the computing node to cause the processor to perform a method comprising:
reading an input data block;
determining a compressibility of the input data block;
compressing the data block when the compressibility exceeds a predetermined threshold;
encrypting the data block based on a keyed hash; and
providing the encrypted data block with associated metadata, the associated metadata comprising an indication of the compressibility and the keyed hash.

10. The system of claim 9, wherein reading the input data block comprises reading a data stream and extracting the input data block therefrom.

11. The system of claim 9, wherein determining the compressibility of the input data block comprises compressing the input data and comparing a compressed length thereof to an uncompressed length thereof.

12. The system of claim 9, wherein said compressing comprises applying a convergent encryption scheme.

13. The system of claim 9, the method further comprising deduplicating the encrypted data block against a plurality of additional encrypted data blocks.

14. The system of claim 13, the method further comprising passing the encrypted data block and associated metadata in parallel to a storage controller, and wherein said deduplicating is performed by the storage controller.

15. A computer program product for data encryption, the computer program product comprising a computer readable storage medium having program instructions embodied therewith, the program instructions executable by a processor to cause the processor to perform a method comprising:
reading an input data block;
determining a compressibility of the input data block;
compressing the data block when the compressibility exceeds a predetermined threshold;
encrypting the data block based on a keyed hash; and
providing the encrypted data block with associated metadata, the associated metadata comprising an indication of the compressibility and the keyed hash.

16. The computer program product of claim 15, wherein reading the input data block comprises reading a data stream and extracting the input data block therefrom.

17. The computer program product of claim 15, wherein determining the compressibility of the input data block comprises compressing the input data and comparing a compressed length thereof to an uncompressed length thereof.

18. The computer program product of claim 17, wherein said compressing comprises applying a convergent encryption scheme.

19. The computer program product of claim 17, further comprising deduplicating the encrypted data block against a plurality of additional encrypted data blocks.

20. The computer program product of claim 19, further comprising passing the encrypted data block and associated metadata in parallel to a storage controller, and wherein said deduplicating is performed by the storage controller.
